(19) United States
(12) Patent Application Publication
(10) Pub. No.: US 2002/0169977 A1
(43) Pub. Date: Nov. 14, 2002

(54) System, methods, and apparatus for distributed wireless configuration of a portable device

(76) Inventor: Mazen Chmaytelli, San Diego, CA (US)

Correspondence Address: QUALCOMM Incorporated, Attn: Patent Department, 5775 Morehouse Drive, San Diego, CA, 92121-1714, US

(21) Appl. No.: 09/854,277

(22) Filed: May 11, 2001

(51) Int. Cl. H04L 9/32

(52) U.S. Cl. 713/200

(57) ABSTRACT

A method of configuring a portable device includes sensing user-identifying information (P110), which may include biometric data. A user identification token based on the user-identifying information is produced (P120) and transmitted to a network (P130), and a set of configuration information is received (P140).

### BACKGROUND

1. Field of the Invention

The present invention relates to portable devices. More particularly, the present invention relates to wireless configuration of portable devices.

2. Background Information

A wireless communications system includes a communications network and a set of access terminals (ATs) that communicate with the network over wireless communications links. The communications network may also communicate with other networks (over links that may be wired and/or wireless) such that an AT may communicate with an entity within the network, with another AT connected to the network, and/or with an entity and/or an AT on another network.

One example of a wireless communications network is a cellular network for wireless communications. Entities within such a network may include one or more base stations (having base station transceivers or ‘BTSs’) and administrative units (such as base station controllers (BSCs), mobile services switching centers (MSCs), and home and visitor location registers (HLRs and VLRs, respectively)). The ATs of a system including such a network may reside within mobile units (also called ‘mobile stations’) that communicate with one or more of the base stations over a radiolink. A mobile unit may be a cellular telephone, a computer or other processing device connected to a wireless modem, a wireless local loop (WLL) station, or a personal digital assistant (PDA) having wireless connection capability.

Through the base stations, the mobile units may communicate with each other and/or with devices on other networks such as the Internet and/or the public switched telephone network (PSTN). A wireless communications link between a base station and a mobile unit may conform to a cellular telephony interface standard as promulgated by the Telecommunications Industry Association (TIA, Arlington, Va.), such as IS-54, IS-136, IS-95/A/B, and IS-2000; or by the European Telecommunications Standards Institute (Sophie Antipolis, France), such as one of the GSM interfaces. Communications over such a link may also be conducted using one or more data protocols such as the Wireless Application Protocol (WAP, as specified in documents published by WAP Forum, Mountain View, Calif.) or a standard for a cellular packet data interface such as IS-856 (as promulgated by the TIA).

Another example of a wireless communications network is a wireless local-area network (LAN), where the entities within the network may include one or more servers and an individual AT may reside within or otherwise be connected to a workstation, a peripheral device, or a PDA. A wireless communications link in such a system may conform to a standard such as IEEE 802.11 (or a variant thereof such as IEEE 802.11a or 802.11b, as specified in documents published by IEEE Standards Association, Piscataway, N.J.) or Shared Wireless Access Protocol (SWAP, as specified in documents published by HomeRF Working Group, Portland, Oreg.).

An AT may be provided within a stationary device, such as a stationary wireless local loop (WLL) station (e.g. a telephone deskset), a desktop computer, or a peripheral device such as a printer or a display or mass storage unit. In such case, the wireless capability eliminates the expense and/or inconvenience of installing and maintaining a wired connection between the network and the stationary device. Alternatively, an AT may be provided within a portable device. In this case, the added dimension of mobility provides portable convenience and access capabilities over a geographical area that may extend within a home or facility or across a continent or beyond.

As portable devices become more versatile and capable, it is desirable to configure them to present a familiar interface to the user for negotiating the various options and capabilities that may be available. For example, a user may program a cellular telephone to default to a particular ringer tone, backlighting option (e.g. on, off, or flashing), and/or presentation banner. It may also be desirable for the portable device to respond to user actions in an expected manner. For example, a user may program a device to perform a particular one among several possible actions (e.g. to display a particular menu) when a predetermined key or sequence of keys is depressed. Additionally, it may be desirable for a portable device to store personalized data values or data sets that are relevant to its capabilities. For example, a cellular telephone may be programmed with a list of frequently called numbers and associated name tags, and a PDA may be programmed with a list of frequently used e-mail addresses and/or the addresses of frequently visited webpages.

In some situations, it may be desirable to support multi-user use of a portable device. For example, a personal communications device such as a cellular telephone, cellular or satellite pager, or handheld radio might be used by different users at different times. In a family (or office) situation, it may be desirable for one or more such devices to be available for a family member (or worker) to take along when he or she leaves the house (or facility). In an industrial or retail setting, it may be desirable for a single configurable device (such as a bar code scanner or other inventory control device) to be shared between several or many workers (e.g. on different days or during different work shifts), allowing a greater utilization of the device and reducing or eliminating device idle time. For a portable device that is likely to become obsolete before being worn out, increasing the duty cycle of the device in this manner may help to reduce equipment costs.

Unfortunately, a configuration that suits one user may be inappropriate or inconvenient for another user, and reentering a manual configuration into a portable device at every use period may be tedious. Moreover, a portable device may have capabilities or data that are appropriate for use or access by one user but not by another.

### SUMMARY

Embodiments disclosed herein address the above stated needs by obtaining user-identifying information corresponding to a user of a portable device and obtaining configuration information for the portable device based on the user-identifying information. In a configurable portable device according to one embodiment, the user-identifying information (which may include biometric data) is sensed, and a user identification token based on the user-identifying information is produced and transmitted to a network. In a network according to one embodiment, a user identification token (which may be based on biometric data) is received, and a corresponding set of configuration information is transmitted.

### BRIEF DESCRIPTION OF THE DRAWINGS

FIG. 1 is a block diagram of a system according to an embodiment of the invention;

FIG. 2 is a block diagram of a portable device 100 according to an embodiment of the invention;

FIG. 3 is a block diagram of a communications network 200 according to an embodiment of the invention;

FIG. 4 illustrates a flowchart of a method according to an embodiment of the invention;

FIG. 5 illustrates a flowchart of a method according to a further embodiment of the invention;

FIG. 6 illustrates a flowchart of a method according to another embodiment of the invention;

FIG. 7 illustrates a flowchart of a method according to a further embodiment of the invention;

FIG. 8 illustrates a flowchart of a method according to another embodiment of the invention;

FIG. 9 illustrates a flowchart of a method according to a further embodiment of the invention; and

FIG. 10 illustrates a flowchart of a method according to a further embodiment of the invention.

### DETAILED DESCRIPTION

It may be desirable to change a configuration of a portable device based upon the identity of the user. For example, it may be desirable to configure an interface presented to the user by the device, to configure access to data stored in the device, to configure an operation of the device, and/or to configure an interaction between the portable device and a communications network. It may also be desirable to control or manage access to certain capabilities, options, or data of a portable device according to the identity of the user.

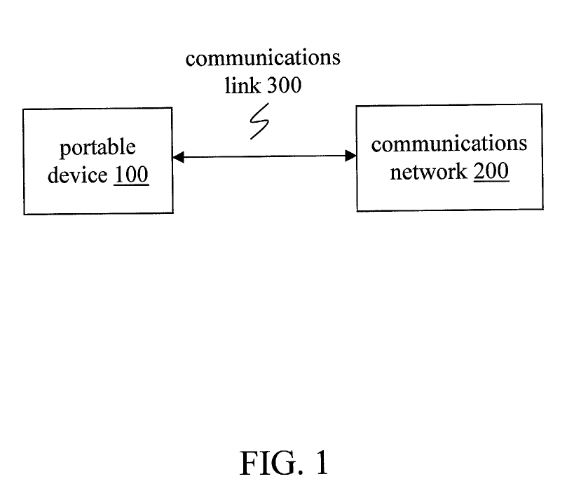

FIG. 1 shows a block diagram of a system according to an embodiment of the invention that includes a portable device 100 and a communications network 200. A suitable example of communications network 200 may include a portion of a cellular network for wireless communications and/or a wireless LAN as mentioned above. On a smaller scale, a suitable example of network 200 may include a personal computer (possibly connected to a LAN) that communicates with one or more PDAs or other portable devices through a wireless interface. In this case, the interface may include a wireless communications link 300 that is magnetic, inductive, optical (e.g. infrared, possibly conforming to IrDA Serial Infrared Data Link Standard Specifications published by Infrared Data Association, Walnut Creek, Calif.), and/or radio (e.g. conforming to an interface standard such as IEEE 802.11 or a variant thereof, SWAP, or Bluetooth (as specified in documents published by the Bluetooth Special Interest Group, New York, N.Y.)).

In a system as shown in FIG. 1, portable device 100 obtains information from the user, creates a user identification token with that information, and transmits the token over wireless communications link 300 to communications network 200. In response, network 200 transmits to portable device 100 a set of configuration information corresponding to the token. In one implementation, network 200 detects a correspondence between the token and one of a number of prestored templates and transmits a set of configuration information that corresponds to that template.

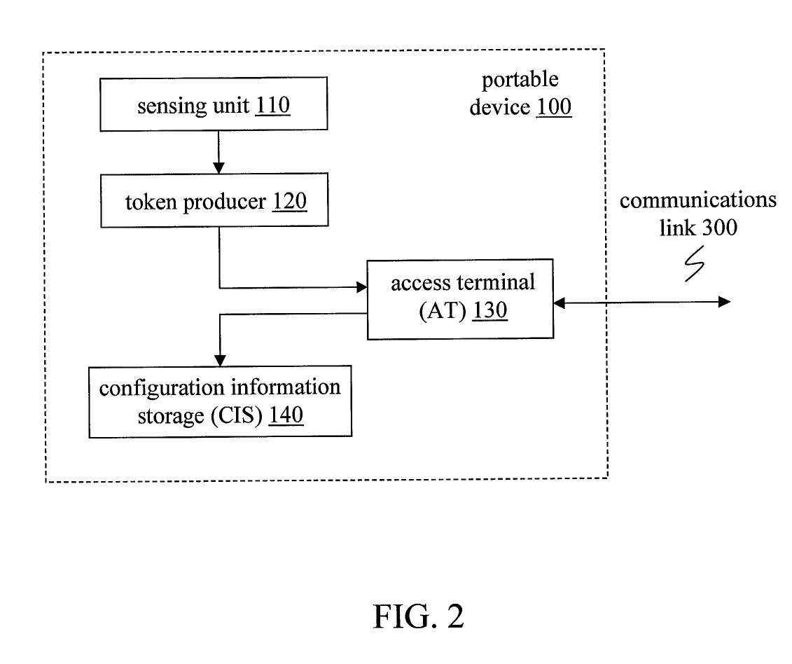

As shown in FIG. 2, a portable device according to an embodiment of the invention includes a sensing unit 110, a token producer 120, an AT 130, and configuration information storage 140. Sensing unit 110 senses information identifying the user. For example, sensing unit 110 may include an imaging unit (e.g. a charge-coupled device (CCD) or complementary metal-oxide-semiconductor (CMOS) sensor) configured to collect biometric data such as an image of a user's fingerprint, iris, or face. In a further biometric implementation, sensing unit 110 is a microphone or other sound transducer (possibly already provided within the portable device), and the user enters identifying information by speaking a predetermined passphrase (such as her name) into the unit.

In another implementation, sensing unit 110 includes an imaging unit configured to collect an image of an identifying symbol or string of symbols (such as a bar code) printed on a surface (e.g. a user identification tag such as an employee badge). Alternatively, sensing unit 110 may include a photodiode that senses light (e.g. from a laser diode or LED) that is reflected off of a printed surface. In a further implementation, sensing unit 110 includes a magnetic sensor for reading a string of data symbols from a magnetic stripe affixed to a user identification tag. In such cases, sensing of the information may require the user to move the surface and/or the device relative to each other (e.g. to swipe the tag through a slot on the device where sensing unit 110 is disposed). Alternatively, sensing unit 110 may include a keyboard by which the user enters a password or other identifying string of characters.

An identification task may include comparison of user identification information to one or more prestored user templates. Depending on the nature of the sensed data, the amount of processing required to put such data into a form suitable for input to an identification task may vary greatly. For example, a passphrase entered using a keyboard may be inputted directly to an identification task. Similarly, a data string entered by swiping a magnetic stripe or bar code may be put into such a form relatively easily (e.g. by digitizing the string and possibly performing additional conditioning tasks such as minimum guard area verification and error detecting and/or correcting tasks such as parity checking and checksum verification). In such cases, these tasks may be performed within portable device 100 by token producer 120, so that the user identification token transmitted to network 200 is suitable for direct input to an identification task.

For biometric data such as a voice impression or an image of a face, iris, or fingerprint, however, the task of extracting a set of identifying features from the sensed data may be much more intensive. For an image of a fingerprint, feature extraction may include identifying the locations of minutiae (features such as ridge endings and bifurcations). For an image of an iris, feature extraction may include locating the inner and outer boundaries of the iris annulus and deriving characteristic parameters using a technique such as wavelet decomposition. For an image of a face, feature extraction may include normalizing the size of the captured image to include only facial features and filtering the reduced image to determine those features. For a voice impression, feature extraction may include endpoint determination and/or deriving mel-frequency or linear prediction cepstral coefficients (MFCCs or LPCCs, respectively) from the sensed speech data. In a portable device 100 that includes a digital cellular telephone, an alternative method of speech feature extraction may include using an existing vocoder to reduce the sensed data into a set of features. In other such cases, however, it may not be possible or desirable for portable device 100 to perform the entire extraction operation, and the user identification token outputted by token producer 120 may require further processing to complete the operation of extracting a set of features.

Token producer 120 processes the data outputted by sensing unit 110 to produce a user identification token. In some implementations, token producer 120 may perform the entire feature extraction operation. In a case where the tasks of feature extraction exceed the capabilities of token producer 120, but the set of sensed data is not too large (e.g. in comparison with the capacity of link 300), the user identification token may include the entire data set, possibly after normalization and/or compression, and feature extraction may be performed or completed within network 200. In a further implementation, the feature extraction operation may be divided between portable device 100 and network 200 (e.g. according to the amount of processing power available, the amount of communications bandwidth available, and the nature of the extraction and identification algorithms).

Token producer 120 may be implemented as one or more microprocessors, digital signal processors, or other arrays of logic elements executing one or more sequences of instructions stored in hardware, firmware, and/or software. For example, token producer 120 may include a portion of an application-specific integrated circuit (ASIC) or field-programmable gate array (FPGA), and the instruction sequences may be stored on-chip and/or off-chip in a volatile storage element such as static or dynamic semiconductor random-access memory (RAM) or a nonvolatile storage element such as read-only memory (ROM), programmable ROM (PROM), or flash or ferroelectric RAM. In a particular implementation, portable device 100 includes an array of logic elements that executes instructions relating to the tasks of token producer 120 at one time and instructions relating to other tasks (e.g. tasks associated with AT 130) at another time.

In one implementation, AT 130 transmits the user identification token to network 200 over communications link 300 and receives the configuration information from network 200 over link 300 in response. Access terminal 130 may be any device capable of providing two-way wireless connectivity between portable device 100 and network 200 over a wireless communications link as described above. For example, AT 130 may include one of the MSM (mobile station modem) series of IC devices produced by Qualcomm Incorporated (San Diego, Calif.). Portable device 100 may be a cellular telephone that includes AT 130, or AT 130 may be external to portable device 100 (such as a wireless modem implemented in a PCMCIA card or other attachment). In another implementation, AT 130 may receive the configuration information over a different communications link, or another component of portable device 100 may receive the configuration information. It is understood that AT 130 may perform operations including but not limited to framing, packetizing, encoding (e.g. error-correcting coding), interleaving, puncturing, modulation, and filtering on the user identification token before transmission, such as may be required by particular interfaces and/or protocols associated with link 300.

In response to transmission of the user identification token, network 200 transmits a set of configuration information corresponding to the user to portable device 100 as described herein. As noted above, AT 130 may receive the set of configuration information over link 300 or another link, or another device within or connected to portable device 100 may receive the set of configuration information. Configuration information storage (CIS) 140 stores the set of configuration information, which may include (but is not limited to) one or more of the following:

(1) a data value or string that directs portable device 100 to access one among several prestored lists or sets of data: e.g. a list of telephone numbers, e-mail addresses, and/or favorite webpages. The selection may serve as a default value that the user may change in order to select another list or set; alternatively, access by the user to other lists or sets may be prevented. These lists or sets may be stored in CIS 140 or elsewhere within portable device 100. In a further implementation, the configuration information stored in CIS 140 may itself contain one or more such lists or sets.

(2) a data value or string that chooses or defines one or more default interface features such as ringer sound or tune, backlight operation, and a mapping of a keystroke to a particular function or to a particular sequence of keystrokes (i.e. a ‘macro’).

(3) a data value or string that selects a default from among several prestored data items, objects, or strings, such as an e-mail signature block or presentation banner. These data items, objects, or strings may be stored in CIS 140 or elsewhere within portable device 100.

(4) a data value or string that affects an operation of the device, such as selection of one or more operating frequencies of a portable radio, selection of a display option such as a program icon, or selection of an operating mode (e.g. selection between cellular telephone operation and pager operation, or between a employee's daily operations menu and a manager's special operations menu).

(5) a data value or string that activates or otherwise permits use of privileges, service options, or software programs (e.g. a web browser or an MP3 player, perhaps associated with display of an appropriate icon).

(6) a data value or string that controls or manages access to locally stored data (such as passwords or other identification tokens, credit card account numbers or other financial information, or other proprietary data).

(7) a data value or string that configures an interaction between portable device 100 and network 200, such as an assignment to device 100 of one among several telephone or pager numbers, voice mail boxes, or greeting messages. For a portable device 100 that includes a cellular telephone, for example, such a data value may indicate which number assignment module (NAM) of portable device 100 is to be active.

(8) a data value or string that configures an interaction between portable device 100 and another network, such as a password for entry to a remote server, or a protocol selection for communications across an additional communications link.

In one implementation, the user may modify some or all of the set of configuration information stored in CIS 140. Such changes may be effective only until the configuration information is overwritten (e.g. by another set of configuration information received from network 200) or, alternatively, information regarding the changes may be transmitted to network 200 to modify the appropriate entry or entries of the configuration information database. In the latter case, the transmitted information may characterize the entire new set of configuration information or may only characterize the features that have changed.

In another implementation, the user may be prevented from changing information stored in CIS 140. For example, access to information may be prevented by altering a mechanism for locating the information. In a storage system that includes an operating system, access to information may be prevented by erasing or otherwise altering directory entries associated with the information. In a password-protected storage system, access to information may also be prevented by altering a stored reference password.

Capabilities and data that are selected by the configuration information may already be stored in portable device 100 (e.g. in nonvolatile storage). Alternatively, the set of configuration information may itself include data values, lists, sets, etc. and/or software programs as described above. If desirable, all or part of the set of configuration information may be compressed before transmission by network 200 and decompressed within portable device 100 (whether before storage to CIS 140 or after retrieval from CIS 140).

In one implementation, CIS 140 is a volatile storage element (e.g. static or dynamic RAM). In this case, the set of configuration information may be retained only for a predetermined period or until power is lost, at which time portable device 100 may be reset to a default configuration (or disabled). Alternatively, portable device 100 may be reset or disabled according to a schedule (e.g. corresponding to a shift change). In such a case, a set of configuration information that has been stored for longer than a predetermined period (e.g. longer than 15 minutes) may be reset at a specified time. In a further alternative, portable device 100 may be reset or disabled upon a specified event.

A resetting task may include erasing or overwriting all or a portion of the configuration information or otherwise making such information inaccessible, while a disabling task may include erasing or otherwise making inaccessible information (possibly part of the configuration information) that is necessary to one or more operations of portable device 100. In a further example, access to configuration information may be prevented by erasing or otherwise altering a decoding or decryption mechanism by which the information is transformed into an intelligible or otherwise useful form. For example, the configuration information may include a key necessary to decode other configuration information (e.g. a string of symbols that is associated with a correspondence between the stored information and an unencrypted form of the stored information) that may be erased or otherwise altered.

In another implementation, the user may be expected to retain control of portable device 100 across one or more power cycles (i.e. turning the device off, then on again). In such case, it may be desirable for CIS 140 to be nonvolatile, especially in a case where it would be inconvenient but necessary to return portable device 100 to the vicinity of network 200 in order to reestablish wireless link 300. Alternatively, CIS 140 may be a volatile storage element with battery backup to support retention of stored data across a power cycle.

Portable device 100 may also transmit a device identification token identifying itself and/or its characteristics to network 200. For example, it may be desirable for network 200 to support reconfiguration of several different types of portable devices (or several different models of a portable device) by sending a set of configuration information that is appropriate for the particular capabilities of the portable device in use.

In the example of a CDMA (code-division multiple access) system that complies with at least one of the IS-95/A/B or IS-2000 standards referenced above, a mobile unit has a ten-digit mobile identification number (MIN) that includes four digits from the mobile unit's unique electronic serial number (ESN) and six digits from an identification string that is known to the network. In a case where portable device 100 is a mobile unit, all or part of the unit's MIN may serve as the device identification token. In another example, the device identification token includes information regarding the configurability of the device and/or data stored therein. In an exemplary implementation, the device identification token is stored within portable device 100 in a nonvolatile storage element.

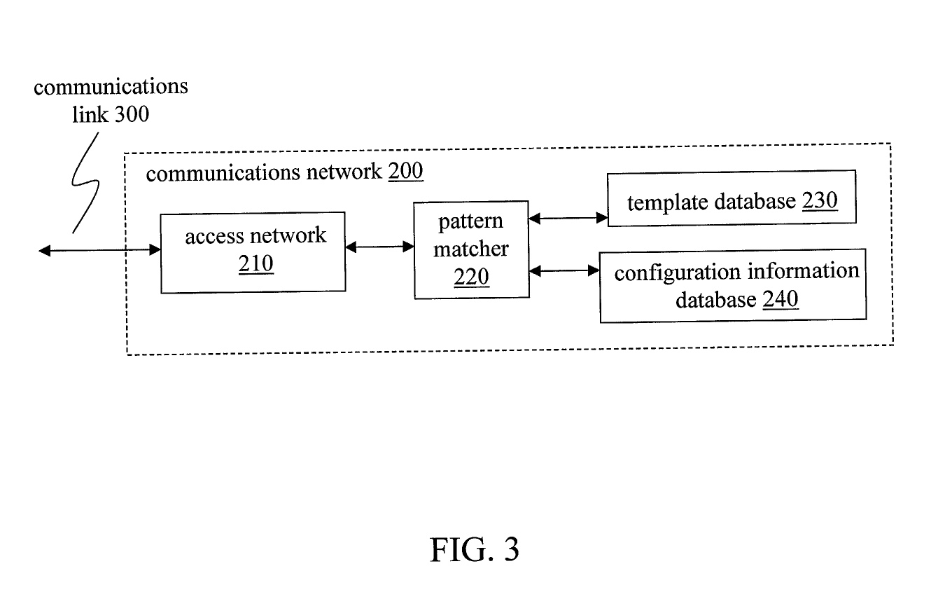

FIG. 3 shows a block diagram of a communications network 200 according to an embodiment of the invention. An access network 210 receives a user identification token from portable device 100 over wireless communications link 300. Upon completing feature extraction tasks as described above (if necessary), pattern matcher 220 matches the information in the user identification token to one among several templates stored in a template database 230 and retrieves a set of configuration information corresponding to the matched template from configuration information database 240. Access network 210 transmits the set of configuration information to portable device 100. Network 200 may be constructed as one device or as several devices at one location. Alternatively, the components of network 200 as shown in FIG. 3 may be physically separated from each other.

Access network 210 may be any device capable of providing two-way wireless connectivity between portable device 100 and network 200 over a wireless communications link as described above. For example, access network 210 may be a portion of a cellular telephone BTS or a wireless LAN base station. In another example, access network 210 may be a Bluetooth transmitter or transceiver, or a wireless docking unit. It is understood that the act of receiving the user identification token may include other operations such as deframing, depacketizing, decompressing, decoding, deinterleaving, and demodulating as may be required by particular interfaces and/or protocols associated with link 300.

Pattern matcher 220 receives the user identification token. In one implementation, an exact correspondence is expected (for example, the token includes a code sensed from an employee badge), and pattern matcher 220 determines whether the token maps to any template in template database 230. In another implementation, an exact correspondence is not expected, and pattern matcher 220 compares the token (or a set of features derived by pattern matcher 220 from the token) to templates in template database 230. For example, pattern matcher 220 may apply an appropriate discriminant function or other pattern recognition technique to the set of features, and a match may be determined in accordance with one or more predetermined thresholds. In selecting a matching template, pattern matcher 220 may compare the set of features to the template of only a small list of users authorized to use the particular device 100, or it may search for a match among all available templates (in an order that may differ according to the particular device 100). Pattern matcher 220 may always choose a template (e.g. according to the best match), or it may reject the user identification token if no match is found to within a specified tolerance. In one example, pattern matcher 200 is set (e.g. in response to a report that the device 100 has been lost or stolen) to notify an external device or system if no template matching the set of features is found. Before sending the configuration information to portable device 100, network 200 may echo the identification to the user (e.g. visually or aurally) for confirmation.

Pattern matcher 220 may be implemented as one or more microprocessors, digital signal processors, or other arrays of logic elements executing one or more sequences of instructions stored in hardware, firmware, and/or software. For example, pattern matcher 220 may include a portion of an application-specific integrated circuit (ASIC) or field-programmable gate array (FPGA), and the instruction sequences may be stored on-chip and/or off-chip in a volatile storage element such as static or dynamic semiconductor random-access memory (RAM) or a nonvolatile storage element such as read-only memory (ROM), programmable ROM (PROM), or flash or ferroelectric RAM. In a particular implementation, network 200 includes an array of logic elements that executes instructions relating to the tasks of pattern matcher 220 at one time and instructions relating to other tasks (e.g. tasks associated with access network 210) at another time. In a situation where more than one portable device may communicate with network 200 through access network 210 at one time, pattern matcher 220 may perform matching tasks on sets of features relating to different user identification tokens serially and/or in parallel.

Upon detecting a suitable correspondence between the user identification token and a template, pattern matcher 220 retrieves a set of configuration information that corresponds to the matched template from configuration information database 240. Before it is forwarded to access network 210 for transmission to portable device 100, the set of configuration information may be compressed. For example, it may be desirable to compress a list of data items such as phone numbers, e-mail addresses, or web favorites before transmission.

As discussed above, portable device 100 may also transmit a device identification token to network 200. For example, the device identification token may be received as a part of an interface transmission such as an access request or a registration request. Configuration information database 240 may include more than one set of configuration information for a particular user template, with the device identification token being applied to direct the selection of the appropriate set of configuration information. Alternatively, the set of configuration information may be reduced after retrieval (possibly before transmission to portable device 100) to include only information indicated by the device identification token.

One or both of template database 230 and configuration information database 240 may be external to network 200. For example, these databases may be stored in a unit such as a HLR or VLR. In a particular implementation, the templates and/or configuration information are communicated to network 200 using a Signaling System 7 (SS7) protocol (e.g. as detailed in ITU-T Q701-Q.741, International Telecommunications Union, Geneva, Switzerland). Alternatively, the templates and/or configuration information may be communicated to network 200 using one or more protocols such as Ethernet, Transmission Control Protocol (TCP) and/or Internet Protocol (IP). In one application, network 200 may also be set (manually or in response to a command from an external unit) to prevent access to the user or otherwise to modify a set of configuration information sent for a particular user and/or device.

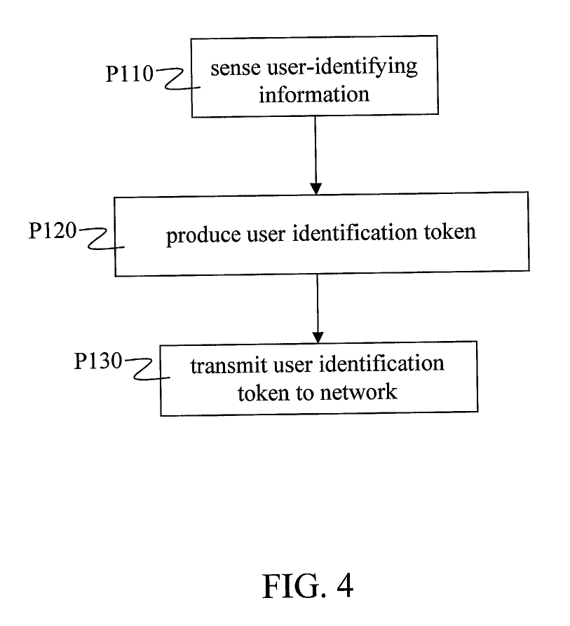

FIG. 4 shows a flow chart of a method of configuring a portable device according to an embodiment of the invention. Such a method may occur at power-up or when the user picks up or otherwise initiates a use of the device. Such a method may also recur periodically and/or upon specified events such as registration or selection of a particular task (e.g. placing a telephone call or performing a purchase transaction).

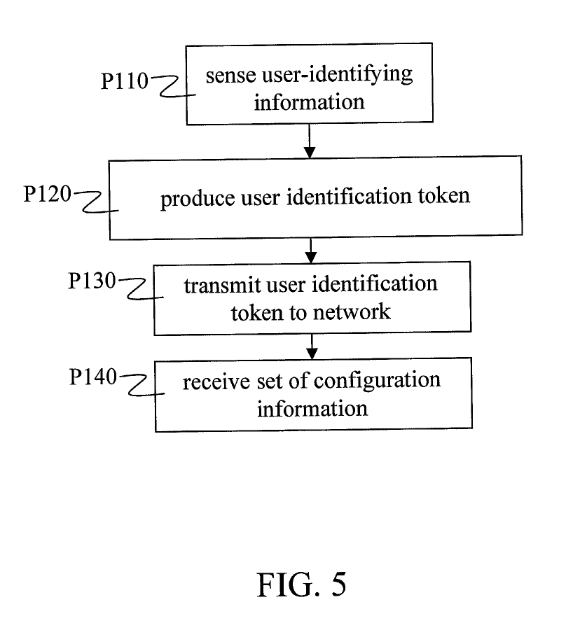

Task P110 senses user-identifying information. As noted above, such information may include biometric data (such as fingerprint, iris, or voiceprint information) and/or other information that may be keyed or scanned into a portable device. Task P120 formats a user identification token based on the sensed information. Task P120 may include all of part of an operation of extracting features from the sensed information. Task P130 transmits the user identification token to the network. In implementations relating to a cellular telephone or similar network, task P130 may transmit the token over a dedicated traffic or control channel or over a non-dedicated channel such as a paging channel or broadcast channel. In a method according to a further embodiment of the invention as shown in FIG. 5, task P140 receives a set of configuration information from the network.

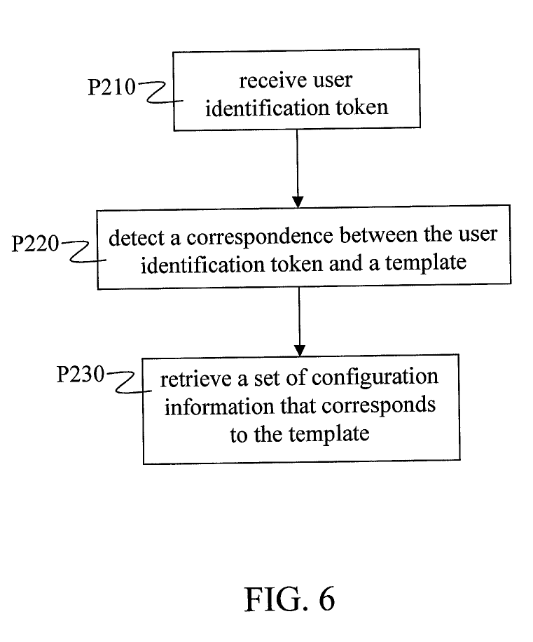

FIG. 6 shows a flow chart of a method of configuring a portable device according to another embodiment of the invention. Task P210 receives a user identification token. Task P220 detects a correspondence between the received token and a template. As described above, task P220 may include all or part of an operation of extracting features from the user identification token. Task P220 may detect an exact match between a set of features from the token and a particular template, or task P220 may detect a best match (e.g. within a specified tolerance or set of tolerances). Task P230 retrieves a set of configuration information that corresponds to the selected template. The set of configuration information may be retrieved from a database stored locally or externally.

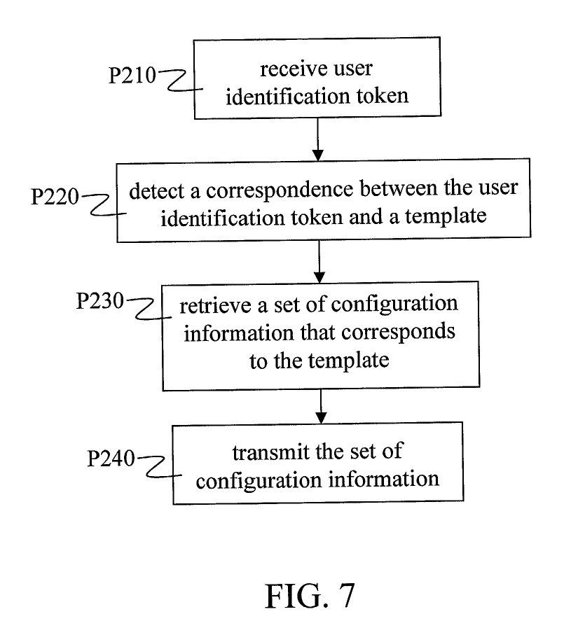

The set of configuration information may be applied locally (e.g. to configure an interaction with a portable device according to the particular user). Identity-driven operations may include locating a particular user for paging purposes (e.g., to direct notification of an incoming call) and/or performing tasks such as billing, message forwarding, service differentiation, purchase authorization and recording, data synchronization, etc. on a per-user basis rather than a per-device basis. In a method according to an alternate embodiment of the invention as shown in FIG. 7, task P240 transmits the set of configuration information (e.g. to a portable device as described herein).

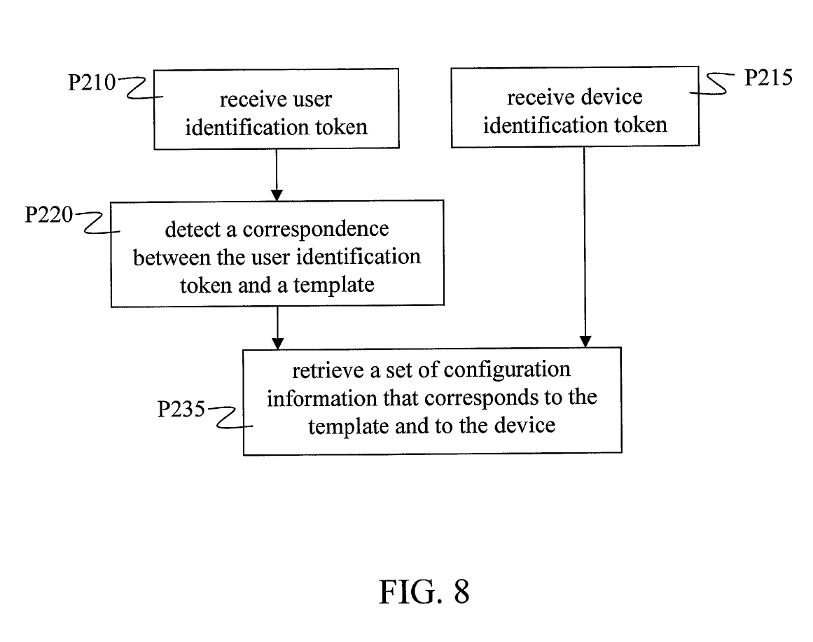

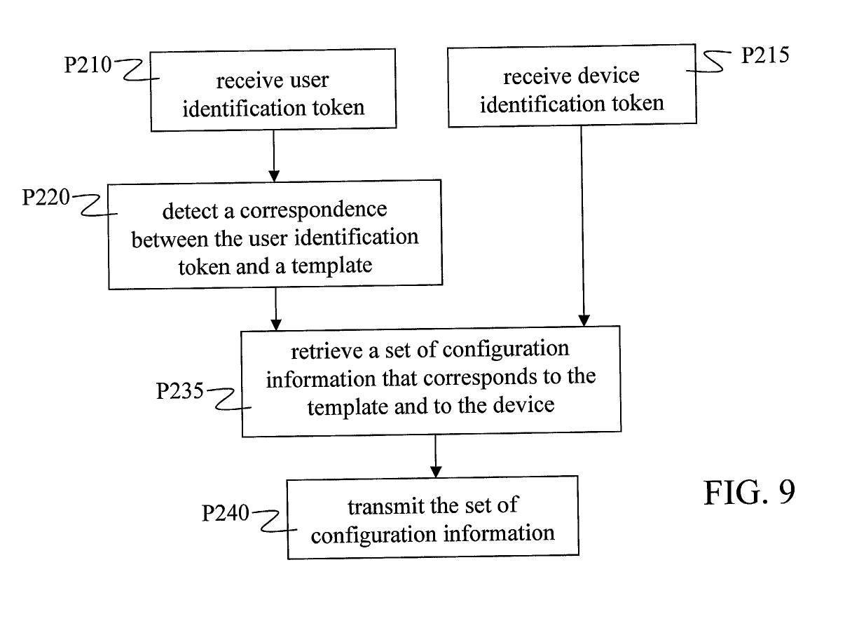

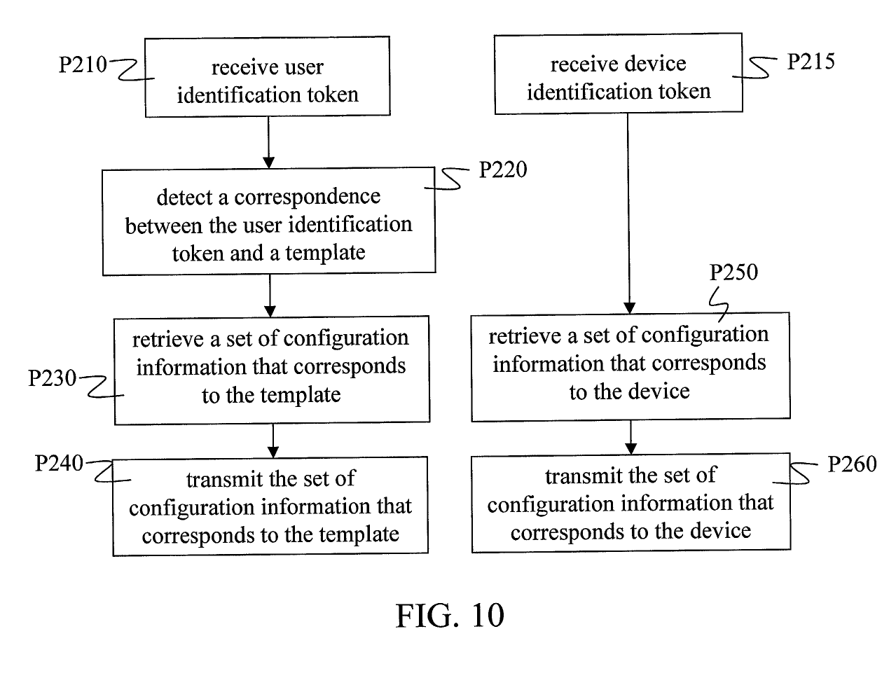

FIG. 8 shows a flowchart of a method according to another embodiment of the invention. In this embodiment, task P215 receives a device identification token, and task P235 retrieves a set of configuration information that corresponds to a selected template and to the device as indicated by the device identification token. FIG. 9 shows a flowchart of a method according to a further embodiment of the invention including task P240 described above. FIG. 10 shows a flowchart of a method according to an alternate embodiment of the invention in which tasks P230 and P250 retrieve sets of configuration information that correspond to the selected template and to the device as indicated by the device identification token, respectively, and tasks P240 and P260 transmit these sets (e.g. to the device), possibly at different times, over different links, and/or according to different events and/or schedules.

In an exemplary implementation, portable device 100 is a mobile unit such as a cellular telephone that communicates with a network 200 over a wireless communications link 300 that complies with one of the CDMA standards referenced above. In another implementation, the communications link 300 complies with a TDMA (time-division multiple access) standard such as GSM (Global System for Mobile Communications, as issued by European Telecommunications Standards Institute (ETSI), Sophie Antipolis, France) or a FDMA (frequency-division multiple access) standard such as the Advanced Mobile Phone System (AMPS).

The foregoing presentation of the described embodiments is provided to enable any person skilled in the art to make or use the present invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, or as a firmware program loaded into non-volatile memory or a software program loaded from or into a data storage medium as machine-readable code, such code being instructions executable by an array of logic elements such as a microprocessor or other digital signal processing unit. Thus, the present invention is not intended to be limited to the embodiments shown above, any particular sequence of instructions, and/or any particular configuration of hardware but rather is to be accorded the widest scope consistent with the principles and novel features disclosed in any fashion herein.

What is claimed is:

1. A configurable portable device comprising:
a sensing unit configured and arranged to collect biometric data from a user of the portable device;
a token producer configured and arranged to produce a user identification token based on the biometric data;
an access terminal configured and arranged to transmit the user identification token to a network over a wireless communications link and to receive configuration information corresponding to the user identification token from the network; and
configuration information storage configured and arranged to retrievably store the configuration information,
wherein a configuration of the portable device is determined at least in part by a portion of the configuration information.

2. The configurable portable device according to claim 1, wherein one among a plurality of number assignment modules of the portable device is selected by the configuration information.

3. A method of configuring a portable device, said method comprising:
sensing user-identifying information from a user of the portable device;
producing a user identification token based on the user-identifying information;
transmitting the user identification token over a wireless communications link; and
receiving a set of configuration information corresponding to the user identification token.

4. The method of configuring a portable device according to claim 3, wherein sensing user-identifying information includes collecting biometric data.

5. The method of configuring a portable device according to claim 4, wherein collecting biometric data includes collecting fingerprint data.

6. The method of configuring a portable device according to claim 4, wherein collecting biometric data includes collecting voice data.

7. The method of configuring a portable device according to claim 3, wherein transmitting the user identification token comprises transmitting the user identification token over a wireless communications link associated with a cellular network for wireless communications.

8. The method of configuring a portable device according to claim 3, further comprising selecting one among a plurality of number assignment modules of the portable device according to the set of configuration information.

9. The method of configuring a portable device according to claim 3, further comprising configuring an operation of the portable device according to the set of configuration information.

10. A method of configuring a portable device, said method comprising:
receiving a user identification token over a wireless communications link;
detecting a correspondence between the user identification token and one among a plurality of templates;
retrieving a set of configuration information that corresponds to the template; and
transmitting at least a portion of the set of configuration information to the portable device.

11. The method of configuring a portable device according to claim 10, wherein the user identification token includes biometric data.

12. The method of configuring a portable device according to claim 11, wherein the user identification token includes fingerprint data.

13. The method of configuring a portable device according to claim 11, wherein the user identification token includes voice data.

14. The method of configuring a portable device according to claim 10, wherein detecting a correspondence between the user identification token and one among a plurality of templates comprises extracting a set of features from the user identification token.

15. The method of configuring a portable device according to claim 10, further comprising receiving a device identification token,
wherein the at least a portion of the set of configuration information corresponds to the device identification token.

16. A configurable portable device comprising:
a sensing unit configured and arranged to sense user-specific information from a user of the portable device;
a token producer configured and arranged to produce a user identification token based on the user-specific information;
an access terminal configured and arranged to transmit the user identification token to a network over a wireless communications link and to receive configuration information corresponding to the user identification token from the network; and
configuration information storage configured and arranged to retrievably store the configuration information,
wherein a user-selectable operation of the portable device is determined at least in part by a portion of the configuration information.

17. The configurable portable device according to claim 16, wherein the sensing unit is configured and arranged to collect biometric data from a user.

18. The configurable portable device according to claim 17, wherein the sensing unit is configured and arranged to collect fingerprint data.

19. The configurable portable device according to claim 17, wherein the sensing unit is configured and arranged to collect voice data.

20. The configurable portable device according to claim 16, wherein the access terminal is configured and arranged to transmit the user identification token over a wireless communications link associated with a cellular network for wireless communications.

21. The configurable portable device according to claim 16, further comprising a plurality of number assignment modules,
wherein the set of configuration information indicates a selected one among the number assignment modules.

22. The configurable portable device according to claim 16, further comprising a display interface,
wherein a configuration of the display interface is determined by the set of configuration information.

23. A network comprising:
an access network configured and arranged to receive a user identification token from a portable device;
a template database configured and arranged to store a plurality of user templates;
a configuration information database configured and arranged to retrievably store a plurality of sets of configuration information, each set corresponding to one among the user templates; and
a pattern matcher coupled to the access network and configured and arranged to detect a correspondence between the user identification token and one among the plurality of user templates and to retrieve the set of configuration information corresponding to the user template.

24. The network according to claim 23, wherein the pattern matcher is configured and arranged to detect a correspondence between biometric data of the user identification token and one among the plurality of user templates.

25. The network according to claim 24, wherein the pattern matcher is configured and arranged to detect a correspondence between fingerprint data of the user identification token and one among the plurality of user templates.

26. The network according to claim 24, wherein the pattern matcher is configured and arranged to detect a correspondence between voice data of the user identification token and one among the plurality of user templates.

27. The network according to claim 23, wherein the pattern matcher is configured and arranged to extract a set of features from the user identification token and to detect a correspondence between the set of features and the one among the plurality of user templates.

28. The network according to claim 23, wherein the access network is further configured and arranged to receive a device identification token from the portable device and to transmit a set of configuration information corresponding to the device identification token.
